(19) United States
(12) Patent Application Publication
(10) Pub. No.: US 2020/0321794 A1
(43) Pub. Date: Oct. 8, 2020

(54) BATTERY CHARGE CONTROLS

(71) Applicant: HEWLETT-PACKARD DEVELOPMENT COMPANY, L.P., Spring, TX (US)

(72) Inventors: Vinh Vo, San Diego, CA (US); Sudish Mukundan, San Diego, CA (US); Chris Kruger, San Diego, CA (US); Jacob Lowman, San Diego, CA (US)

(21) Appl. No.: 16/479,966

(22) PCT Filed: Dec. 8, 2017
(86) PCT No.: PCT/US2017/065298

§ 371 Date: Jul. 23, 2019

(51) Int. Cl. H02J 7/00

(52) U.S. Cl. CPC H02J 7/0048; H02J 7/00036; H02J 7/0071

(57) ABSTRACT

An example method includes detecting a connection to a mobile device by a processor of an accessory device. A battery control policy is received from the mobile device for charging a battery of the mobile device. A battery charge of the mobile device is controlled in accordance with the battery control policy by the processor.

### BACKGROUND

Devices can be connected to accessories via a wired or wireless connection. Accessories can provide additional functionality of the devices over the wired or wireless connection. Thus, the accessories can extend the usefulness of the devices with the additional functionality. The accessories can include a wide variety of different types of devices such as a docking station, voice activated modules, displays, and the like.

### BRIEF DESCRIPTION OF THE DRAWINGS

FIG. 1 is a block diagram of an example system that includes an accessory device connected to a mobile device;

FIG. 2 is a block diagram of an example accessory device to provide power to the mobile device based on a battery control policy;

FIG. 3 illustrates an example graphical user interface of the mobile device to allow a user to set the battery control policy of the present disclosure;

FIG. 4 is a flow chart of an example method for receiving a battery control policy from a mobile device that is implemented by an accessory device to control a battery charge of the mobile device;

FIG. 5 is a block diagram of an example non-transitory computer readable storage medium storing instructions executed by a processor to transmit a battery control policy; and

FIG. 6 is a block diagram of an example non-transitory computer readable storage medium storing instructions executed by a processor to control a battery charge of a mobile device based on a battery control policy received from the mobile device.

### DETAILED DESCRIPTION

Examples described herein provide battery charge controls. Some mobile devices may be connected to an accessory device. The accessory device may be used to charge a battery of the mobile device. However, the accessory device may have no user interface that allows a user to see how the battery of the accessory device is being used, to implement a battery charge policy, and the like.

However, the mobile device may include a user interface. Thus, examples of the present disclosure allow a user to implement a battery charge control policy for the accessory device via the user interface of the mobile device. The battery charge control policy may be transmitted from the mobile device to the accessory device such that the accessory device may execute, or implement, the battery charge control policy.

In addition, updates, notifications, and changes to the accessory device's battery charge control policy may be provided through the user interface of the mobile device. As a result, the examples of the present disclosure provide an approach to enable battery charge control policies to control battery usage of accessory devices to be provided via the mobile device connected to the accessory device.

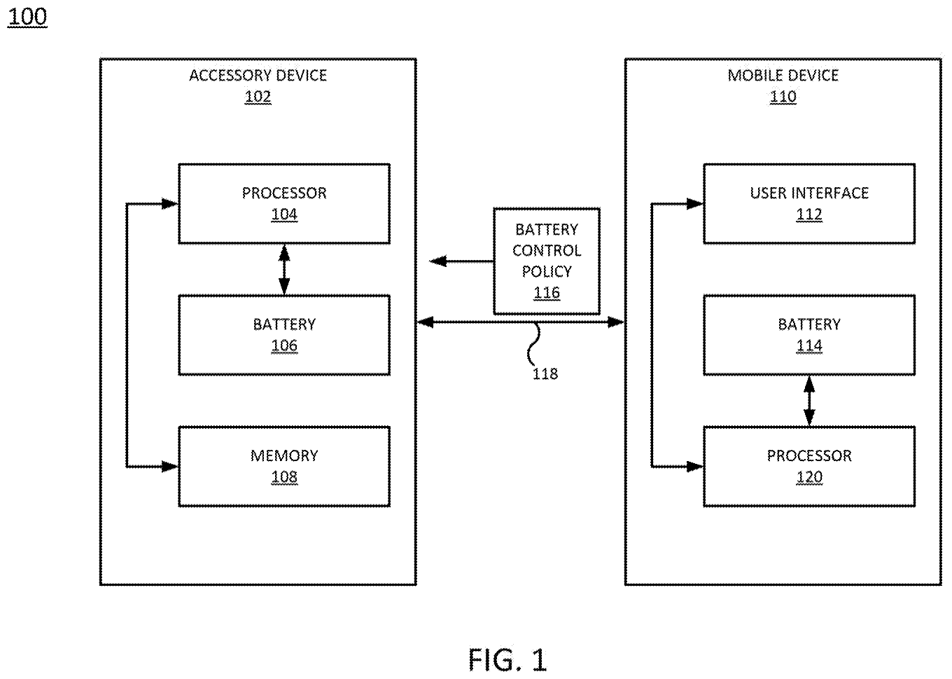

FIG. 1 illustrates an example system 100 of the present disclosure. In one example, the system 100 may include an accessory device 102 and a mobile device 110. The accessory device 102 may be any type of device that does not include a user interface, or does not include a user interface capable of allowing a battery control policy to be created. The accessory device 102 may not include an indication or display that provides information such as a remaining battery life or battery usage to a user. For example, the accessory device 102 may be a portable docking station, a portable bar code scanner, and the like.

In one example, the accessory device 102 may include a processor 104, a battery 106, and a memory 108. The processor 104 may be communicatively coupled to the battery 106 and the memory 108. The memory 108 may be a non-transitory computer readable medium such as a hard disk drive, a random access memory (RAM), read only memory (ROM), and the like.

In one example, the mobile device 110 may be connected to the accessory device 102 via a connection 118. The connection 118 may be a wired or wireless connection. The connection 118 may be able to provide a communication path and a power path. For example, the communication path may allow the accessory device 102 and the mobile device 110 to exchange data or information and the power path may allow power to flow from the battery 106 towards the mobile device 110.

In one example, the mobile device 110 may be a smart phone, a tablet computer, a laptop computer, and the like. The mobile device 110 may include a user interface 112 a battery 114, and a processor 120. The processor 120 may be communicatively coupled to the user interface 112 and the battery 114.

In one example, the mobile device 110 may charge the battery 114 via the battery 106 over the connection 118. However, since the accessory device 102 has no user interface, the mobile device 110 may consume all of the battery life of the battery 106 without any battery control policies in place. In addition, disconnection may not be an option since the user may want to use the accessory device 102 with the mobile device 110.

In one example, the user may use the user interface 112 to generate a battery control policy 116 for the accessory device 102. The battery control policy 116 may then be transmitted via the connection 118 to the accessory device 102. The battery control policy 116 may be stored in the memory 108 and executed by the processor 104 to control battery charging operations of the battery 106.

Notably, the battery control policy 116 that is for the accessory device 102 and implemented by the accessory device 102 originates from the mobile device 110. Said another way, the user interface 112 of the mobile device 110 is used to generate the battery control policy 116 for another device that charges the battery 114 of the mobile device 110.

In one example, the battery control policy 116 may be set by the user based on a desired usage time of the accessory device 102 and a desired battery charge level of the mobile device 110. The mobile device 110 may then calculate an estimated power distribution of the battery 106 to power the accessory device 102 and the mobile device 110. For example, when the mobile device 110 connects to the accessory device 102, the accessory device 102 may transmit initial information associated with the battery 106 via the connection 118. The initial information may include battery life remaining, an estimated drain rate of the battery 106, and the like.

In another example, the user may set the battery control policy 116 based on general preferences. For example, the user may specify to extend the battery life of the battery 114 of the mobile device 110 over the battery life of the battery 106 of the accessory device 102, or vice versa. In another example, the user may specify to balance the battery life of both the battery 114 and the battery 106.

In another example, the user may specify information for the accessory device 102 or the mobile device 110 and the mobile device 110 may calculate an appropriate battery control policy 116. For example, the user may specify to use the accessory device 102 for at least 8 hours. The mobile device 110 may then calculate the maximum battery charging for the battery 114 that would still allow the battery 106 to power the accessory device 102 for at least 8 hours. In another example, the user may specify they want the battery 114 of the mobile device 110 to be charged to a 100% capacity. The mobile device 110 may set the battery control policy 116 to maximize battery charging of the battery 114 regardless of how long the battery 106 will be able to power the accessory device 102.

In one example, after the battery control policy 116 is initially set and executed, information can be exchanged via the connection 118 that can be used to adjust the battery control policy 116. For example, the accessory device 102 may periodically (e.g., every 30 seconds, every minute, every 15 minutes, and the like) transmit battery use information, battery life remaining information, and the like, to the mobile device 110. The mobile device 110 may use the information to calculate a battery drain rate. The battery drain rate may be used to calculate an expected remaining usage time of the accessory device 102.

In one example, the battery drain rate may be calculated by a difference in a remaining battery life at a second time period and a remaining battery life at a first time period divided by the amount of time between the second time period and the first time period. The expected remaining usage time may then be calculated by the remaining battery life or capacity at a current time period divided by the battery drain rate.

The battery life remaining of the accessory device and the expected remaining usage time of the accessory device 102 may be displayed to a user via the user interface 112. The user may then adjust the battery control policy 116 based on the battery life remaining of the accessory device and the expected remaining usage time of the accessory device 102.

The updated battery control policy may be transmitted to the accessory device 102. In one example, the updated battery control policy may cause the accessory device 102 to change the amount of power that is delivered from the battery 106 to the battery 114 of the mobile device 110. In another example, the updated battery control policy may cause the accessory device 102 to stop the battery charge of the battery 114 of the mobile device 110.

In one example, the battery control policy 116 may be pre-defined. For example, the mobile device 110 may execute an application associated with the accessory device 102. The application may then transmit the battery control policy 116 that is predefined to the accessory device 102 when the connection 118 to the accessory device 102 is detected. The predefined battery control policy 116 may be fixed (e.g., set to maximize usage of the battery 106 to power the accessory device 102).

It should be noted that FIG. 1 has been simplified for ease of explanation. For example, the accessory device 102 and the mobile device 110 may include additional components that are not shown.

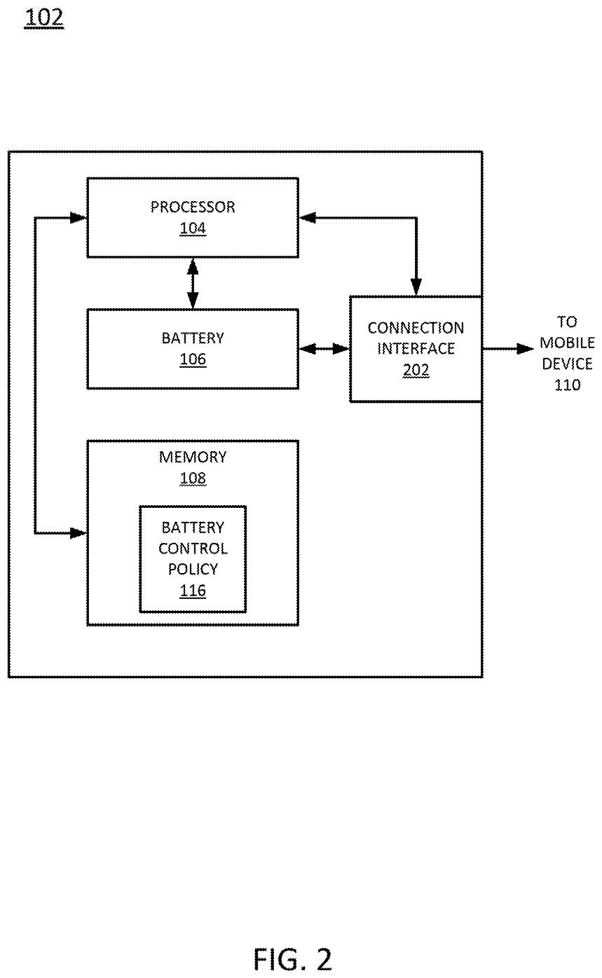

FIG. 2 illustrates a block diagram of the accessory device 102. As shown in FIG. 1, the accessory device 102 may include the processor 104, the battery 106, and the memory 108. In one example, the accessory device 102 may include a connection interface 202. The processor 104 may be communicatively coupled to the battery 106, the memory 108, and the connection interface 202.

The connection interface 202 may be used to connect to the mobile device 110. The connection interface 202 may be a physical connection interface such as a universal serial bus (USB) connection or may be a wireless connection interface such as a WiFi radio, Bluetooth radio, and the like. In one example, the wireless connection interface may also include an inductive charging capability for wireless charging in addition to the wireless communications.

In one example, the battery control policy 116 may be stored in the memory 108. The processor 104 may control battery charging operations of the battery 106 based on the battery control policy 116 that was received from the mobile device 110. For example, the processor 104 may monitor usage of the battery 106. If the usage of the battery 106 would violate the battery control policy 116 the processor 104 may stop sending power from the battery 106 to the battery 114 of the mobile device 110.

In one example, monitoring the usage of the battery 106 may include periodically collecting remaining battery life information and transmitting the information to the mobile device 110. As noted above, the mobile device 110 may calculate estimated remaining usage time of the accessory device 102 and a drain rate of the battery 106. In another example, the processor 104 may locally calculate the battery drain rate and the remaining battery life periodically.

The estimated remaining usage time may be received by the processor 104 and compared against the desired usage time in the battery control policy 116. If a violation occurs, the processor 104 may send a notification to the mobile device 110, stop sending power from the battery 106 to the battery 114, and the like. If no violation occurs, the processor 104 may continue with current battery charging and use operations.

In one example, if the drain rate is calculated locally, the processor 104 may transmit the drain rate to the mobile device 110 to modify or update the battery control policy 116. The updated battery control policy may then be received by the processor 104 and stored in the memory 108 to replace the previously stored battery control policy 116. The processor 104 may then execute the updated battery control policy 116.

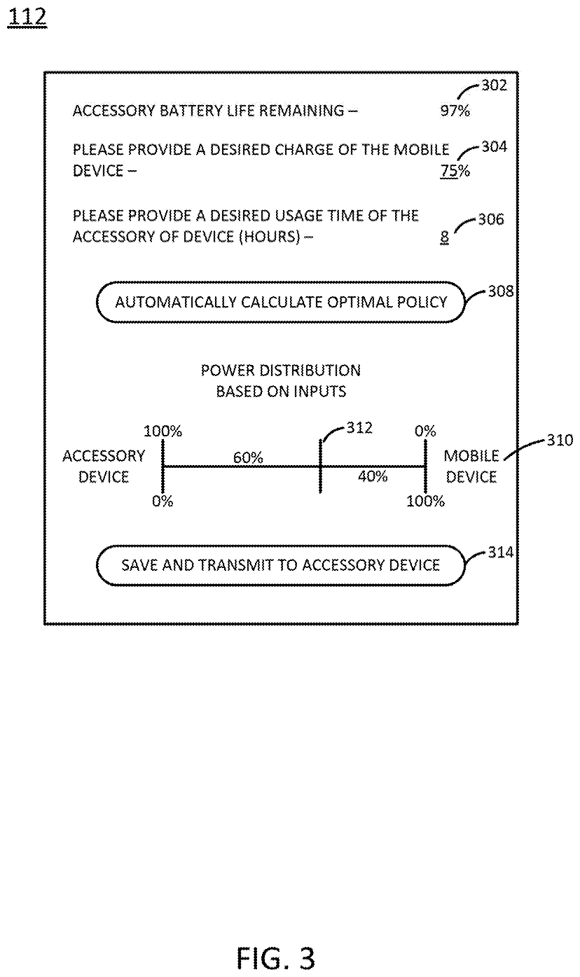

FIG. 3 illustrates an example of the user interface 112 of the mobile device 110. In one example, the user interface 112 may be a graphical user interface (GUI) that includes images and buttons.

The user interface 112 may include various different types of information or requests for input that can be used to set the battery control policy 116. In one example, the user interface 112 may display information 302 such as an accessory battery life remaining. The user interface 112 may request inputs 304 and 306 such as a desired charge of the mobile device and a desired usage time of the accessory device (e.g., in hours, in minutes, and the like).

Based on the inputs 304 and 306, the user may press a button 308 that allows the mobile device 110 to automatically calculate the optimal battery control policy 116. In one example, a slider bar 310 may be displayed. For example, a user may slide a bar 312 between 100% usage for the accessory device 102 and 100% usage for the mobile device 110. For example, the slider bar 310 may be set to 60% usage for the accessory device 102 and 40% usage for the mobile device 110. The mobile device 110 may automatically calculate the battery control policy 116 based on the use percentages set by the bar 312.

In one example, the inputs 304 and 306 may be changed or provided by the mobile device 110 based on where the bar 312 is set. For example, as the user moves the bar 312 along the slider bar 310 to different percentages, the user interface 112 may update the inputs 304 and 306. Thus, a user may see how charge and how much usage time would change based on the different percentage allocations set by the bar 312. When the user is satisfied with the selections, the user may press a button 314 to save and transmit the battery control policy 116 to the accessory device 102.

In one example, the user interface 112 may also be used to show notifications that are transmitted from the accessory device 102. For example, the information 302 that shows a remaining battery life of the accessory device 102 may be periodically updated. In another example, if the battery control policy 116 is violated and the accessory device 102 stops delivering power from the battery 106 to the battery 114, a notification may be displayed in the user interface 112.

In one example, based on the remaining battery life of the accessory device 102 and the calculated drain rate, some selections by the user may not be possible. For example, if the user enters inputs 304 and 306 that are not possible, the user interface 112 may generate a notification that the desired usage time of the accessory device 102 and the desired charge of the mobile device 110 cannot be achieved. In one example, the user interface 112 may display a recommended percentage of power distribution between the mobile device and the accessory device that is close to the inputs 304 and 306. For example, the bar 312 may be automatically positioned on the slide bar 310 for the recommendation.

Thus, the present disclosure provides smart battery charging between a battery of an accessory device and a mobile device. The smart battery charging can be provided despite the accessory device having no user interface that is capable of allowing a user to set a battery control policy. Rather, the user interface of the mobile device may be used to generate a battery control policy that is executed by the accessory device to control battery control operations of the battery of the accessory device.

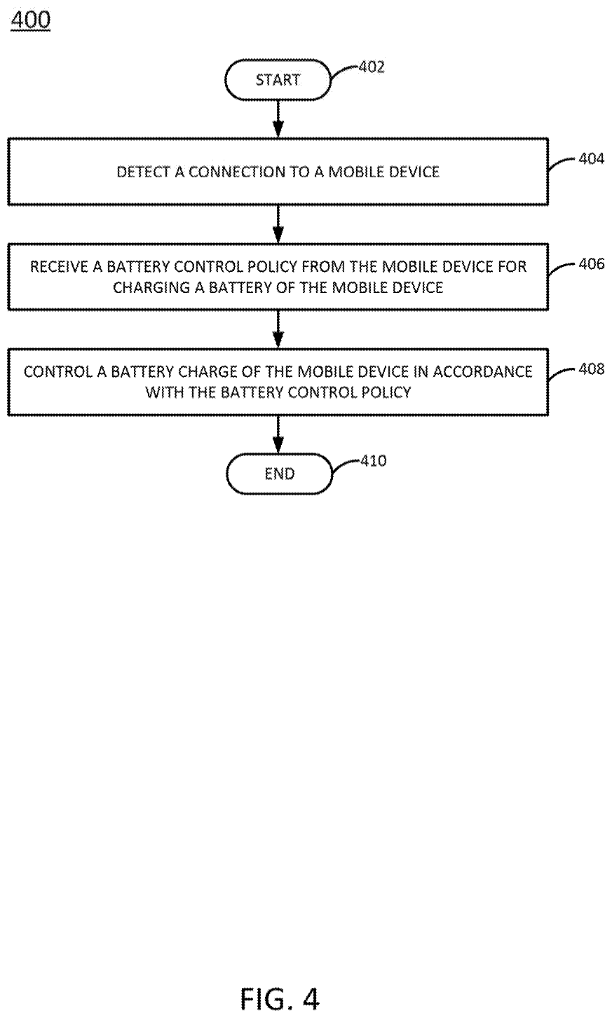

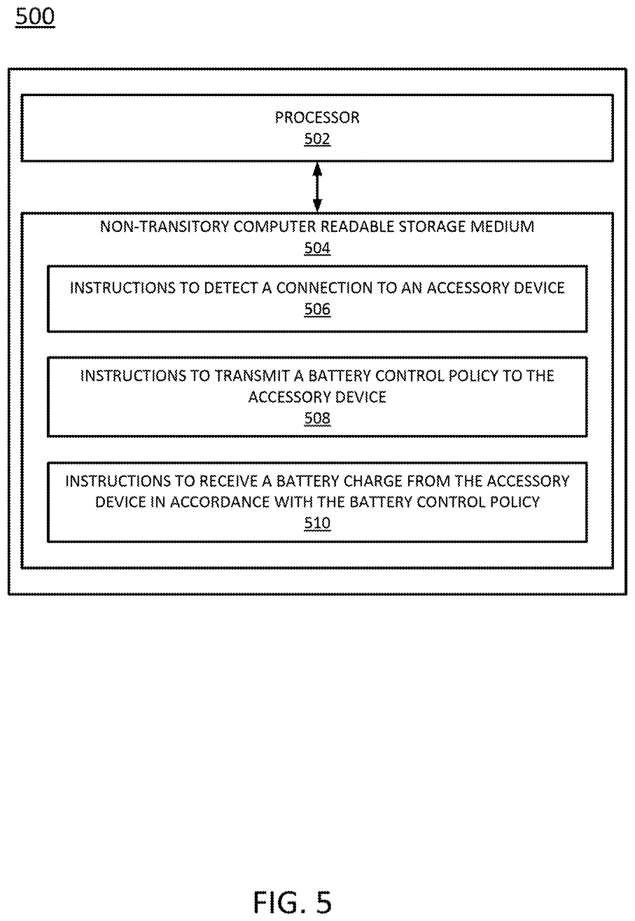

FIG. 4 illustrates a flow diagram of an example method 400 for method for receiving a battery control policy from a mobile device that is implemented by an accessory device to control a battery charge of the mobile device. In one example, the method 400 may be performed by apparatus 100 or the apparatus 500 illustrated in FIG. 5 and described below.

At block 402, the method 400 begins. At block 404, the method 400 detects a connection to a mobile device. For example, when a wired or wireless connection is established with the mobile device via a connection interface, the processor of the accessory device may receive a signal that the connection is established. The connection may also be capable of transmitting power from a battery of the accessory device to the battery of the mobile device.

In one example, the accessory device may transmit initial information related to the battery of the accessory device to the mobile device via the connection. The information may be displayed by the mobile device to a user via a user interface to set an initial battery control policy.

At block 406, the method 400 receives a battery control policy from the mobile device for charging a battery of the mobile device. As discussed above, a user may provide inputs that can be used to generate the initial battery control policy. The inputs provided by the user may be used with a battery drain rate and estimated usage time remaining of the accessory device calculated by the mobile device. In another example, the battery control policy may be pre-defined.

The battery control policy may control how the battery of the accessory device is used. For example, the battery control policy may define the battery charging operation of the battery of the accessory device. In other words, the battery control policy may determine how much power is used by the accessory device to meet a desired usage time of the accessory device. The battery control policy may also determine how much power is delivered to the battery of the mobile device to meet a desired charge level of the mobile device.

As noted above, the battery control policy executed by the accessory device is generated by, and received from, the mobile device that is connected to the accessory device. The accessory device may not have a user interface capable of allowing a user to set battery control policy. However, the user interface of the mobile device may allow a battery control policy to be generated that controls how the battery of the accessory device will charge a battery of the mobile device.

At block 408, the method 400 controls a battery charge of the mobile device in accordance with the battery control policy. For example, the battery control policy may be stored in memory of the accessory device and executed by the processor of the accessory device.

In one example, the blocks 406 and 408 may be periodically repeated. For example, the battery control policy may be updated as parameters change or user inputs change. For example, the drain rate for the battery of the accessory device may suddenly increase. As a result, the user may be notified of this change and the desired amount of battery charge of the mobile device may be reduced to extend the usage time of the accessory device.

In another example, the user may suddenly want to maximize the battery charge of the mobile device. For example, the user may be leaving, stopping use of the accessory device sooner than expected, and be able to charge the battery device of the accessory device at a later time. As a result, the user may want to fully charge, or charge as much as possible, the battery of the mobile device with any remaining charge left on the battery of the accessory device. At block 410, the method 400 ends.

FIG. 5 illustrates an example of an apparatus 500. In one example, the apparatus 500 may be the mobile device 110. In one example, the apparatus 500 may include a processor 502 and a non-transitory computer readable storage medium 504. The non-transitory computer readable storage medium 504 may include instructions 506, 508, and 510 that, when executed by the processor 502, cause the processor 502 to perform various functions.

In one example, the instructions 506 may include instructions to detect a connection to an accessory device. The instructions 508 may include instructions to transmit a battery control policy to the accessory device. For example, the instructions 508 may be performed based on battery information that is received from the accessory device and/or user inputs. The instructions 510 may include instructions to receive a battery charge from the accessory device in accordance with the battery control policy.

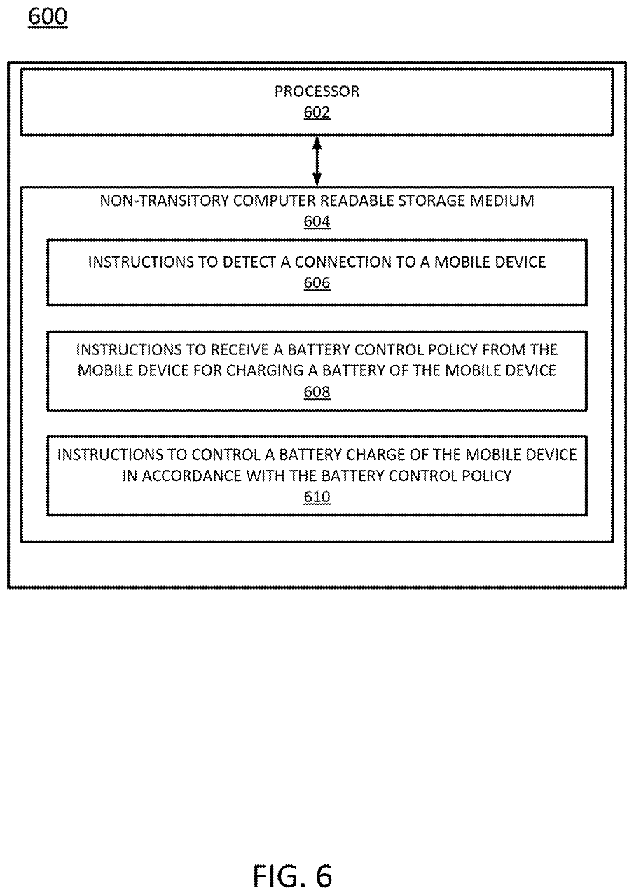

FIG. 6 illustrates an example of an apparatus 600. In one example, the apparatus 600 may be the accessory device 102. In one example, the apparatus 600 may include a processor 602 and a non-transitory computer readable storage medium 604. The non-transitory computer readable storage medium 604 may include instructions 606, 608, and 610 that, when executed by the processor 602, cause the processor 602 to perform various functions.

In one example, the instructions 606 may include instructions to detect a connection to a mobile device. The instructions 608 may include instructions to receive a battery control policy from the mobile device for charging a battery of the mobile device. The instructions 610 may include instructions to control a battery charge of the mobile device in accordance with the battery control policy.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
detecting, by a processor of an accessory device, a connection to a mobile device;
receiving, by the processor, a battery control policy from the mobile device for charging a battery of the mobile device; and
controlling, by the processor, a battery charge of the mobile device in accordance with the battery control policy.

2. The method of claim 1, wherein the accessory device does not include a user interface.

3. The method of claim 1, comprising:
transmitting, by the processor, a remaining battery life periodically to the mobile device.

4. The method of claim 3, comprising:
receiving, by the processor, an updated battery control policy based on a battery drain rate that is calculated by the mobile device from the remaining battery life that was periodically transmitted and the remaining battery life of the accessory device.

5. The method of claim 4, wherein the controlling the battery charge comprises stopping the battery charge of the mobile device in accordance with the updated battery control policy.

6. The method of claim 1, wherein the battery control policy is pre-defined.

7. The method of claim 1, the battery control policy is defined by a user via a graphical user interface (GUI) on the mobile device.

8. A non-transitory computer readable storage medium encoded with instructions executable by a processor, the non-transitory computer-readable storage medium comprising:
instructions to detect a connection to an accessory device;
instructions to transmit a battery control policy to the accessory device; and
instruction to receive a battery charge from the accessory device in accordance with the battery control policy.

9. The non-transitory computer readable storage medium of claim 8, wherein the battery control policy is pre-defined.

10. The non-transitory computer readable storage medium of claim 8, comprising:
instructions to receive a remaining battery life of the accessory device periodically.

11. The non-transitory computer readable storage medium of claim 10, comprising:
instructions to calculate a battery drain rate of the accessory device based on the remaining battery life that is periodically received, an estimated time remaining for the accessory device, and an estimated time remaining for a mobile device of the processor.

12. The non-transitory computer readable storage medium of claim 11, comprising:
instructions to receive a desired usage time of the accessory device and a charge amount a battery of the mobile device associated with the processor;
instructions to calculate a percentage of power distribution between the mobile device and the accessory device; and
instructions to set the battery control policy in accordance with the percentage of power distribution between the mobile device and the accessory device that is calculated.

13. The non-transitory computer readable storage medium of claim 12, comprising:
instructions to generate a notification that the desired usage time of the accessory device and the charge amount of the battery of the mobile device cannot be achieved; and
instructions to provide a recommended percentage of power distribution between the mobile device and the accessory device.

14. An apparatus, comprising:
a processor;
a connection interface to connect to a mobile device;
a battery to provide power to the mobile device via the connection interface in accordance with a battery control policy; and
a memory to store the battery control policy received from the mobile device via the connection interface, wherein the processor is to control charging of the battery based on the battery control policy, and wherein the processor is communicatively coupled to the connection interface, the battery, and the memory.

15. The apparatus of claim 14, wherein the processor is to:
periodically calculate a battery drain rate and a remaining battery life of the apparatus;
transmit the battery drain rate and the remaining battery life to the mobile device; and
receive an updated battery control policy from the mobile device based on the battery drain rate and the remaining battery life of the apparatus.
